(19) United States
(12) Patent Application Publication
(10) Pub. No.: US 2020/0180483 A1
(43) Pub. Date: Jun. 11, 2020

(54) MOTOR-VEHICLE ACCESSORY

(71) Applicants: Steve KOBER, Treuen (DE); Walter MERTEL, Sulzbach-Rosenberg (DE)

(72) Inventors: Steve KOBER, Treuen (DE); Walter MERTEL, Sulzbach-Rosenberg (DE)

(21) Appl. No.: 16/689,396

(22) Filed: Nov. 20, 2019

(30) Foreign Application Priority Data
Nov. 26, 2018 (DE) 102018009229.2

(51) Int. Cl. B60N 2/829; B60N 2/75; B60N 2/821

(52) U.S. Cl. CPC B60N 2/829; B60N 2/77; B60N 2/821; B60N 2/773

(57) ABSTRACT

The invention relates to a motor-vehicle accessory, comprising a moveable first part and a vehicle-fixed second part, wherein the first part is guided on the second part by a guide (43), wherein the guide (43) comprises at least one rack (22a, 22b, 24a, 24b) in engagement with a gear (21a, 21b, 23a, 23b), wherein the rack (22a, 22b, 24a, 24b) is on one of the parts, and the gear (21a, 21b, 23a, 23b) is on the other part.

The particular feature consists in that the guide additionally comprises a tolerance compensation that comprises at least one running rail (26a, 26b, 28a, 28b) on one of the parts and engages a running wheel (25a, 25b, 27a, 27b) on the other one of the parts, wherein the running wheel (25a, 25b, 27a, 27b) and/or the running rail (26a, 26b, 28a, 28b) is elastically deformable, and a press-fit is formed between the running rail and the running wheel, so that the meshing teeth of the first part and of the second part are urged into a defined position.

The invention relates to a motor-vehicle accessory comprising a first part as well as a second part relatively moveable to the first part.

DE 10 2009 038 631 [U.S. Pat. No. 8,534,760] describes a headrest that comprises a base body that can be supported on the backrest of a vehicle seat by support rods. A head contact part is mounted on the base body in a manner moveable forward and back relative to the base body. To guide the head contact part in the base body, meshing teeth are formed on the base body and on the head contact part. The headrest is provided with a clearance compensation device. The clearance compensation device comprises elastic biasing means that urge the meshing teeth of the head contact part and of the base body into mutual contact.

The object of the invention is to create a motor-vehicle accessory that can be produced easily and that has a functionally reliable tolerance compensation in the guide of the head contact part.

The object is achieved by a motor-vehicle accessory having the features of claim 1.

The motor-vehicle accessory comprises a first part and a vehicle-fixed second part, wherein the first part is guided on the second part relatively moveable to the second part by a guide. The guide comprises at least one rack meshing with a gear, wherein the rack is on one of the parts and the gear is on the other part.

The guide additionally includes a tolerance compensation that comprises at least one running rail on one of the parts and engages a running wheel on the other one of the parts. For example, the running rail is on the first part and the running wheel is on the second part. The running wheel and/or the running rail is formed elastically deformable, and a press-fit is formed between the running rail and the running wheel so that the interacting meshing teeth of the first part and of the second part are biased into a defined direction with respect to at least one spatial dimension. Noise that occurs as a result of an uncontrolled relative movement of the meshing teeth can be prevented thereby.

According to a simple configuration, the guide comprises a gear and a rack. According to an alternative embodiment, the guide comprises two racks and two gears for example. In this way, portions of the equipment part that are spaced from one another can be guided. The portions of the equipment part can be lateral portions for example.

Two gears are respectively on one gear shaft for example. Synchronism of the gears can be achieved thereby, because these gears are motion-coupled by the shaft. As a result, one part of the equipment part is prevented from moving slower than another part, thereby jamming the first part.

According to a particular embodiment, the guide comprises two gear shafts, wherein each gear shaft is provided with at least one gear, in particular with two gears, and wherein each gear meshes with one rack.

For example, at least one gear of a first gear shaft and respectively one gear of a second gear shaft are in engagement with one another. This achieves synchronism of the gear shafts.

The guide comprises e.g. at least one pair of running wheel and running rail. The meshing teeth of the gear and of the rack are biased in engagement by the pair of running wheel and running rail in such a way that one of the sets of teeth is pressed against the other set of teeth. Consequently, the teeth will not move to different relative positions in an uncontrolled manner so that noise is prevented.

In particular—caused by the contact pressing device—a force acts on the gear, which force is directed approximately perpendicularly to a longitudinal axis of the rack and loads the gear in engagement with the rack. The running wheel and/or the running rail are formed by an elastically deformable material which, upon elastic deformation, provides for a restoring force into the initial shape. Due to the deformation of the running wheel during installation, a force acts on the gear, because the running wheel is connected with the gear. The contact surface between the running wheel and the running rail can be formed e.g. without texture. Alternatively, the contact surface could also have a texture, however.

The running wheel can be directly or indirectly be connected with the gear for example. For example, the running wheel is molded on the gear. Alternatively, e.g. the running wheel is connected to the gear via a shaft. In this case, the mounting of the shaft has to permit a corresponding movement of the shaft.

For example, at least one running wheel is on one gear shaft, and at least one running rail that interacts with the running wheel is on one rack interacting with a gear of the gear shaft.

In particular, one running wheel is on each gear, and one running rail is on each rack, wherein the respective pair of running wheel and running rail are in engagement. In this way, all meshing teeth are optimally urged into a defined relative position.

At least one pair of running wheel and running rail is arranged adjacently to one pair of gear and rack, for example. For example, the gear and the running wheel as well as the rack and the running rail are arranged directly next to one another. They can be integrally formed for example.

At least one of the parts gear and rack as well as running wheel and running rail can be made from plastic material. Other materials can alternatively be considered, in particular metal.

The motor-vehicle accessory is a headrest for example, wherein the first part is a head contact part that is relatively moveable to a base as a second part.

The motor-vehicle accessory is an armrest for example, wherein the first part is an arm support adjustable in the longitudinal direction or adjustable in height, which arm support is guided on a base as the second part.

Further advantages result from the description of an embodiment schematically shown in the drawing in which:

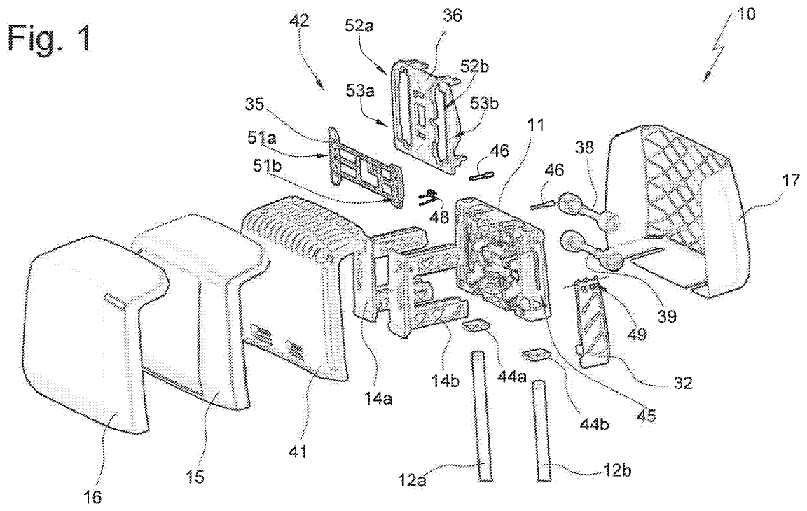

FIG. 1 is an exploded view of a headrest according to the invention as motor-vehicle accessory in the context of the invention,

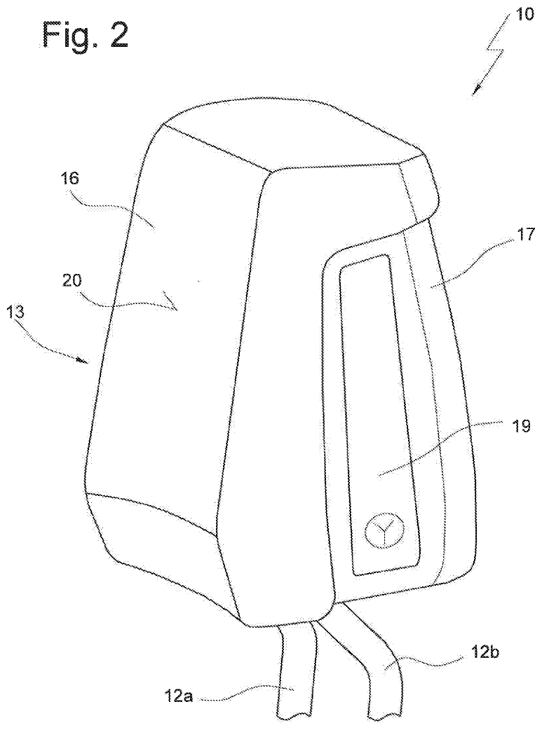

FIG. 2 is a perspective view of the headrest,

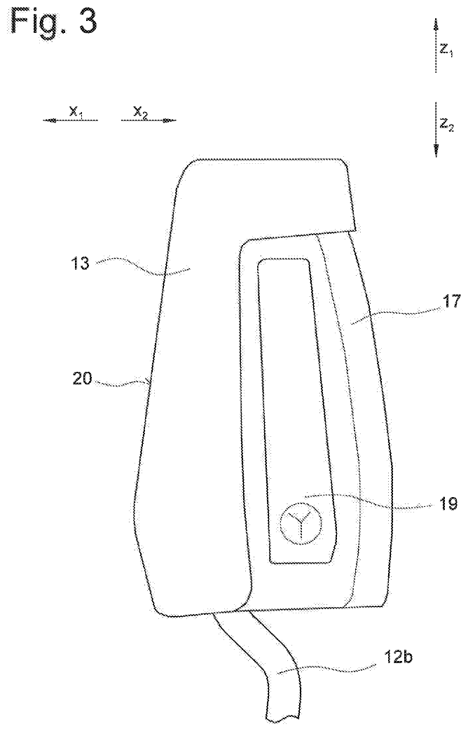

FIG. 3 is a side view of the headrest,

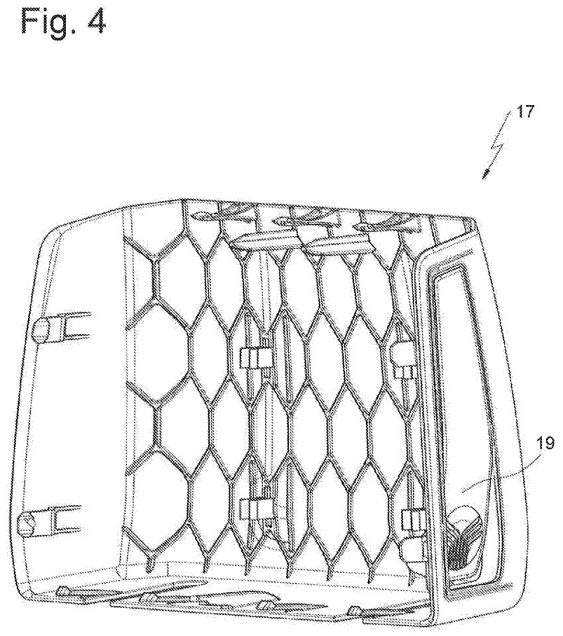

FIG. 4 is a perspective view of a rear cover structure of the headrest as a view of an individual part,

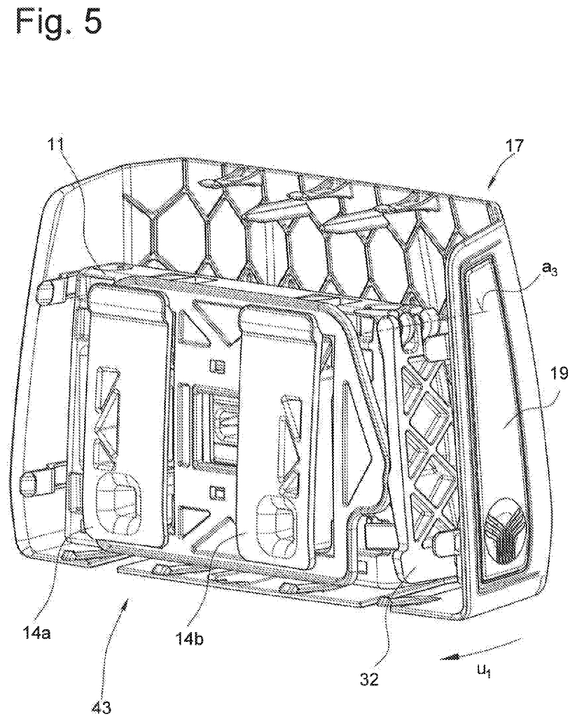

FIG. 5 is a perspective view of an assembly composed of base, mounting elements of the head contact part and rear cover structure,

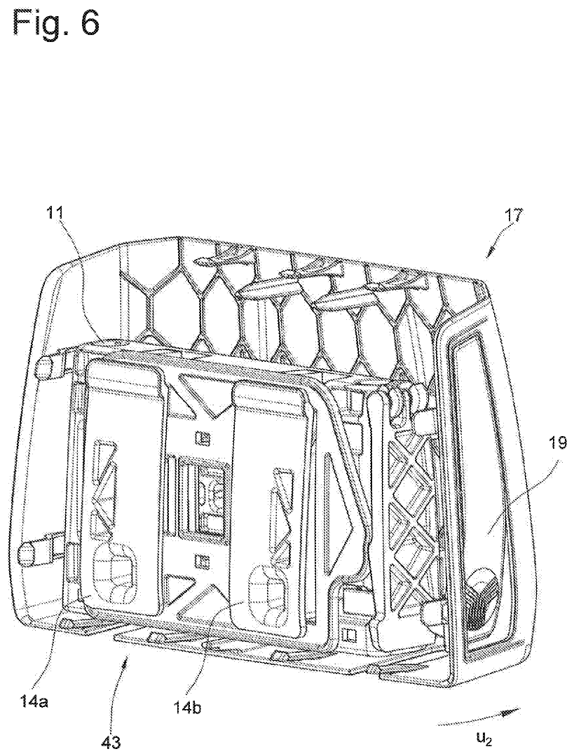

FIG. 6 is a view similar to FIG. 5 where a latch is in the release position,

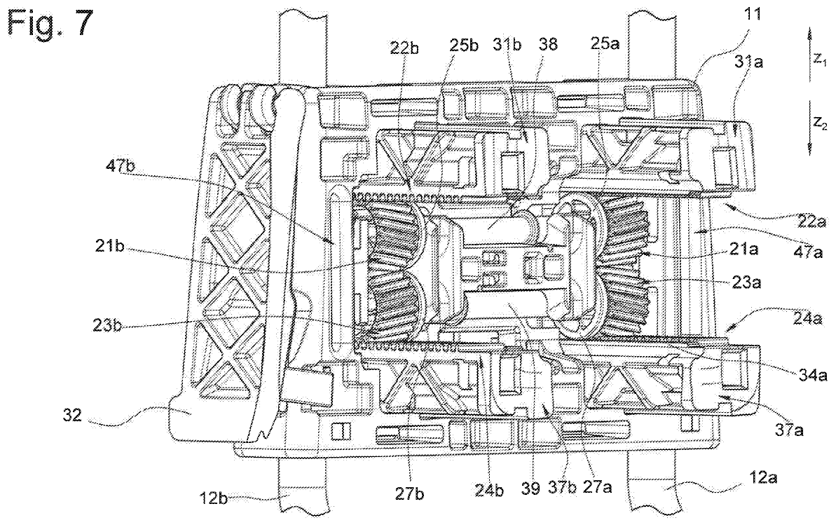

FIG. 7 is a perspective rear view of the base guided on support rods as well as of the mounting elements,

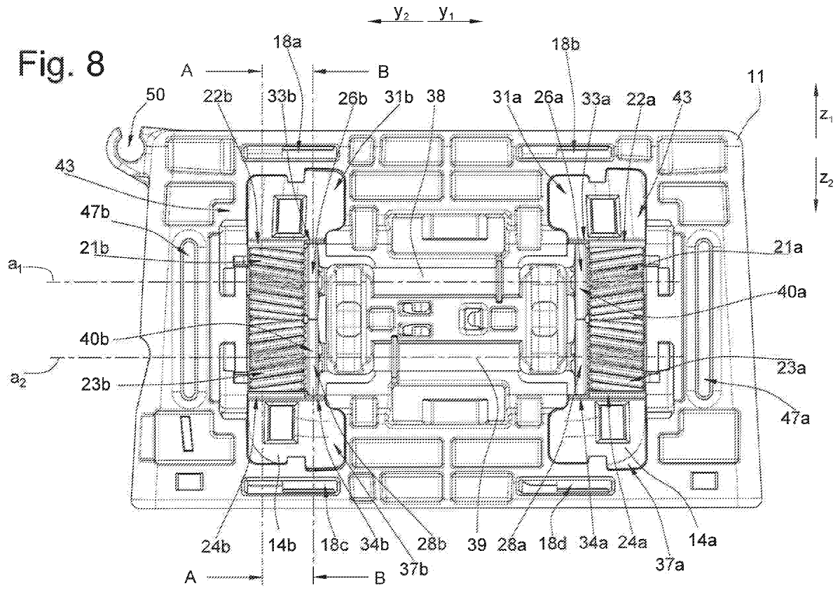

FIG. 8 is a rear view of the base with the mounting elements,

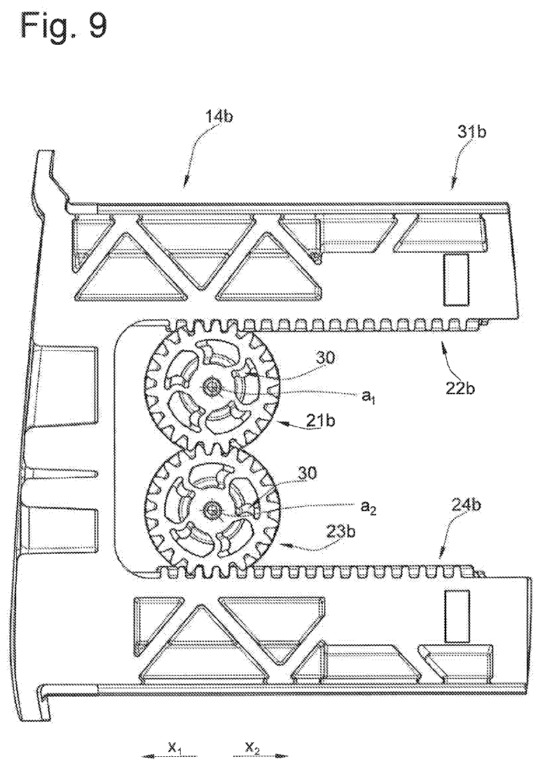

FIG. 9 is a sectional view according to sectional line A-A in FIG. 8 in which only the gear shafts are represented of the base part and in which the hatching is not shown for the sake of clarity, and

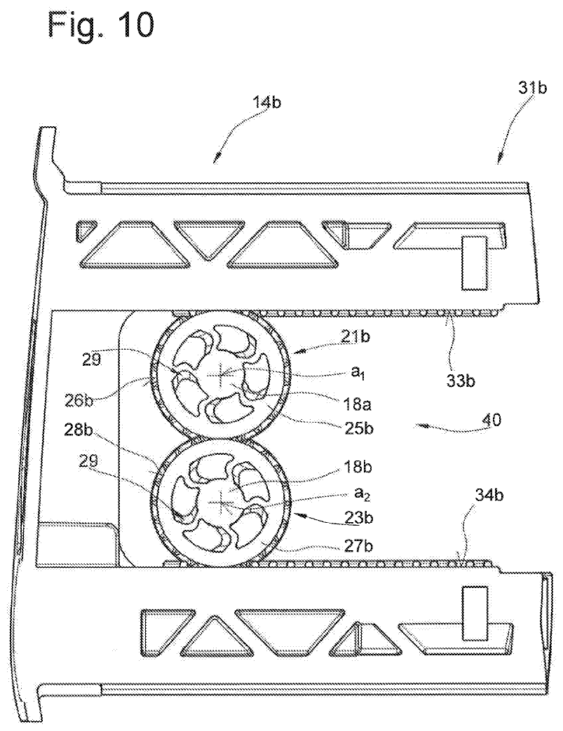

FIG. 10 is a sectional view according to sectional line B-B in FIG. 8 in which only the gear shafts are represented of the base part and in which the hatching is not shown for the sake of clarity.

An embodiment of the invention is described by way of example in the following description of the figures also with reference to the schematic drawings. For the sake of clarity—also as far as different embodiments are concerned—like or equivalent parts or elements or regions are indicated with like reference characters, in some cases with small letters.

Features that are described, illustrated or disclosed only with reference to one embodiment can in the context of the invention also be provided in each other embodiment of the invention. Such modified embodiments are—even though not shown in the drawings—are also covered by the invention.

All features disclosed are per se essential to the invention. The disclosure contents of the mentioned patent documents and the described prior art devices are hereby entirely incorporated in the disclosure of the application, also for the purpose of including individual or multiple features of the subject-matters disclosed there into one or multiple claims of the present application. Such modified embodiments are also covered by the invention—although they may not be illustrated in the drawings.

A headrest as a whole is indicated with reference character 10 throughout the Figures.

The headrest 10 includes a base 11 mounted on support rods 12a and 12b. A support rod bracket could be used as an alternative to the support rods 12a and 12b. To guide the base 11 on the support rods 12a and 12b, mounting bearings 44a and 44b are attached to the base 11, which bearings are traversed by the support rods 12a and 12b. The base 11 can thus be moved to different positions in relation to the support rods 12a and 12b in the directions z₁ and z₂.

A pin 46 engages through an slot 47a of the base 11 and is attached to the support rod 12a. Another pin 46 engages through an slot 47b of the base 11 and is attached to the support rod 12b. Together the with base 11, the pin 46 forms a twist preventer of the support rod 12a and 12b relative to the base 11. In addition, the pin 46 serves to lock the base 11 in the set height position, as yet to be described below.

The headrest 10 comprises a head contact part 13 having a head contact surface 20 displaceable relative to the base 11 in the direction x₁ and x₂. The head contact part 13 is moveable in the direction x₁ toward the head of the person sitting on the seat or in the opposite direction x₂ away from the head. The head contact part 13 comprises two mounting elements 14a and 14b that are attached to a head contact shell 41. The head contact shell 41 forms a housing of the headrest 10 together with a rear cover structure 17. Furthermore, a cushion 15 as well as a cover 16 are attached to the head contact shell 41.

The Z-position of the base 11 as well as the X-position of the head contact part 13 can be unlocked by the latch 42 that can be operated by a user at an actuating element 19. The actuating element 19 is a region independent of the housing wall of the cover structure 17 that can be deformed inwardly and that is moved back into the initial shape by the elastic restoring force of the material upon load removal. The latch 42 comprises a locking slide 35 for arresting the Z-position of the base 11 relative to the support rods 12a and 12b as well as a locking slide 36 for locking the set X-position. The locking slides 35 and 36 are in a manner moveable in the directions y₁ and y₂ urged into the locking position in the direction y₂ by a spring 48. They can be moved in the direction y₁ to the release position by the actuating element 32.

The locking slide 35 includes latching arrangements 51a and 51b that comprise latch seats spaced from one another in the Z-direction and that can be brought into engagement with the pins 46. The locking slide 36 comprises latching webs 52a and 52b as well as 53a and 53b that interact with latch seats of the mounting elements 14a and 14b spaced from one another in the X-direction. The latch seats are formed at the upper and lower ends of the mounting elements 14a and 14b.

The locking slides 35 and 36 can be moved from the locking position to a release position by the handle 19 that interacts with an actuating element 32. In the present embodiment, the actuating element 32 is formed as a lever that can be pivoted around a pivot axis a₃ in the directions u₁ and u₂. The pivot axis a₃ is formed by a mounting axis 49 that is pivotably mounted in a seat 50. However, the handle could alternatively be formed by a push button for example. In this case, the head contact part 13 is moveable both in the X- and Z-directions.

The mounting elements 14a and 14b are part of a guide 43. As can be seen in FIGS. 5 and 6, the mounting elements 14a and 14b are guided on the base part 11. To that end, the mounting element 14a comprises racks 22a and 22b, and the mounting element 14b comprises racks 24a and 24b. The racks 22a and 24a of the mounting element 14a are spaced from one another in the Z-direction and their teeth face one another. Similarly, the racks 22b and 24b of the mounting element 14b are spaced from one another in the Z-direction and their teeth face one another.

Gear shafts 38 and 39 are rotatably mounted on the base part 11. The gear shafts 38 and 39 are between the racks 22a and 24a as well as 22b and 24b. The gear shaft 38 includes gears 21a and 21b meshing with the racks 22a and 22b, and the gear shaft 39 includes gears 23a and 23b that are in engagement with the racks 24a and 24b. In addition, teeth 21a and 23a as well as teeth 21b and 23b are in engagement with one another. In the present embodiment, the gears are molded on the respective shaft. Alternatively, the gears could also be attached to the shaft. All gears 21a, 21b, 23a and 23b have the same diameter and are arranged coaxially to the respective gear shafts 38 and 39. The gears comprise spokes 30. The gears and the racks are provided with bevel teeth. Alternatively, the teeth could however also be formed as straight teeth.

In this way, the head contact part 13 is guided in such a way that tilting around the X-, Y- and Z-axes is prevented.

The headrest 10 includes a contact pressing device 40. The contact pressing device 40 ensures a clearance-free and rattle-free guidance of the head contact part 13. The contact pressing device 40 includes wheels 25a and 25b, the wheel 25a being connected to the gear 21a and the gear 25b on the gear 21b. A wheel 27a is on the gear 23a, and a wheel 27b is on the gear 23b. According to FIG. 8, the wheels 25a and 25b are formed coaxially with a central longitudinal axis a₁ of the gear shaft 38, and the wheels 27a and 27b are formed coaxially with a central longitudinal axis a₂ of the gear shaft 39.

The wheels 25a and 25b comprise running treads 26a and 26b, and the wheels 27a and 27 comprise running treads 28a and 28b. The running treads 26a and 28a as well as 26b and 28b are in contact with one another and roll one on the other as the head contact part 13 is moved in direction x₁ or x₂ on rotation of the gear shafts 38 and 39.

The running tread 26a further is in contact with an even running surface 33a of a running rail 31a, and the running surface 26b is in contact with an even running surface 33b of a running rail 31b. The running surface 33a is next to the rack 22a, and the running surface 33b is arranged laterally of the rack 22b. All wheels 25a, 25b, 27a, 27b comprise spokes 29.

The running surface 28a is in contact with an even running surface 34a of the mounting element 14a, and the running surface 28b is in contact with an even running surface 34b of the mounting element 14b. The running surface 34a is next to the rack 24a, and the running surface 34b is next to the rack 24b. The running surface 34a is formed on a running rail 37a of the mounting element 14a, and the running surface 34b is formed on a running rail 37b of the mounting element 14b. The running rails 37a and 37b are regions of the respective mounting elements 14a and 14b that are in a sliding contact with the base 11.

Each interacting pair of running wheel and running rail is arranged relative to one another in such a way that an interference fit is present between the surfaces of running wheel and running rail. In addition, an interference fit is present between the running wheels of the gear shafts 38 and 39. The shaft 38 is therefore biased in direction z₁, and the shaft 39 is biased in direction z₂. This way, tolerance compensation exits between the teeth, thereby preventing disengagement of the teeth and thus disturbing rattling noises.

The headrest is assembled as follows:

First, the mounting bearings 44a and 44b are mounted on the base 11. After that, the locking slide 35 is inserted through a lateral opening 45 of the base 11. Subsequently, the support rods 12a and 12b are mounted in openings provided for that purpose on the lower side of the base 11. Each support rod 12a and 12b is secured by a pin 46. A pin 46 connected with the support rod 12a engages through a slot 47a, and a pin 46 connected with the support rod 12b engages through a slot 47b of the base 11. This way, the head contact part 13 is moveable in the directions z₁ and z₂ on the support rods 12a and 12b.

Subsequently, the slide 36 is mounted on the base 11 for the purpose of arresting the x-adjustment using openings 18a, 18b, 18c, 18c on the base 11. Thereafter, the return spring 48 is latched on the base 11. The actuating element 32 is engaged with a bearing axle 49 with the seat 50 of the base 11 and is latched at a lower region with the base 11. Thereafter, the gear shafts 38 and 39 are brought into engagement with their seat on the base 11.

The cushion 15 and the cover 16 are fixed on the housing shell 41. Subsequently, the mounting elements 14a and 14b are fixed to the housing shell 41 with their seat. Each mounting element 14a and 14b is secured on the housing shell 41 by a pin (not illustrated). Thereafter, the head contact part 13 with the mounting elements 14a and 14b in front is slid into the base. Finally, the cover 17 is fixed to the rear end regions of each mounting element 14a and 14b as well as to the head contact part 13.

1. A motor-vehicle accessory comprising:
a moveable first part;
a vehicle-fixed second part;
a guide supporting the first part on the second part;
a rack on one of the parts;
a gear on the other of the parts and having teeth meshing with teeth of the rack;
a running rail on one of the parts; and
a running wheel on the other one of the parts, the running wheel or the running rail being elastically deformable, the running rail and the running wheel engaging each other in a press fit such that meshing teeth of the first part and of the second part are urged into a defined position.

2. The motor-vehicle accessory according to claim 1, wherein the guide comprises two such racks horizontally and/or vertically spaced from one another and a corresponding number of gears respectively meshing therewith.

3. The motor-vehicle accessory according to claim 2, wherein two gears are on one gear shaft.

4. The motor-vehicle accessory according to claim 1, wherein the guide has first and second such gear shafts each such gears each meshing with a respective such rack.

5. The motor-vehicle accessory according to wherein two gears of the first gear shaft and two gears of the second gear shaft are in engagement with one another.

6. The motor-vehicle accessory according to claim 1, wherein at least one running wheel or one rack is on the guide.

7. The motor-vehicle accessory according to claim 1, wherein at least one running wheel is on a gear shaft and at least one running rail is on a rack interacting with a gear of the gear shaft.

8. The motor-vehicle accessory according to claim 1, wherein one running wheel is on each gear, and one running rail is on each rack, the one running wheel and the one running rail engaging each other.

9. The motor-vehicle accessory according to claim 1, wherein the running rail is adjacent the rack and the running wheel is adjacent the gear.

10. The motor-vehicle accessory according to claim 1, wherein the motor-vehicle accessory is a headrest and the first part is a head contact part moveable relative to a base as the second part.

11. The motor-vehicle accessory according to claim 1, wherein the motor-vehicle accessory is an armrest and the first part is an arm support adjustable in the longitudinal direction or adjustable in height and is guided in a base as a second part.
